(19) United States
(12) Patent Application Publication
(10) Pub. No.: US 2026/0180024 A1
(43) Pub. Date: Jun. 25, 2026

(54) SOLID ELECTROLYTE COMPOUND, SOLID ELECTROLYTE COMPOSITE CONTAINING THE SOLID ELECTROLYTE COMPOUND, PROCESS FOR MAKING THE SAME, AND SOLID-STATE BATTERY DEVICE COMPRISING THE SAME

(71) Applicant: Solid Power Operating, Inc., Louisville, CO (US)

(72) Inventors: Brian E. FRANCISCO, Arvada, CO (US); Samuel M. OBERWETTER, Lafayette, CO (US)

(21) Appl. No.: 19/423,878

(22) Filed: Dec. 17, 2025

Related U.S. Application Data
(60) Provisional application No. 63/737,734, filed on Dec. 22, 2024.

(51) Int. Cl. H01M 10/0562; H01M 4/62

(52) U.S. Cl. CPC H01M 10/0562; H01M 4/62; H01M 2300/008

(57) ABSTRACT

An argyrodite companion compound having high ionic conductivity and low material hardness, a solid electrolyte composite including the argyrodite companion compound, and a solid state battery device including the argyrodite companion compound and/or the composite. The argyrodite companion compound is a sulfide solid electrolyte compound with a distinctive crystal structure defined by an XRD pattern featuring peaks at 2θ=20.9°±0.5°, 31°±0.5°, and 33°±0.5°. The argyrodite companion compound comprises at least lithium (Li), phosphorus (P), and sulfur (S).

### CROSS-REFERENCE TO RELATED APPLICATION

This application is related to and claims priority under 35 U.S.C. § 119(e) from U.S. Patent Application No. 63/737,734 filed Dec. 22, 2024, titled “Solid Electrolyte Compound, A Solid Electrolyte Composite Containing the Solid Electrolyte Compound, A Process For Making The Same, and A Solid-State Battery Device Comprising the Same,” the entire contents of which is incorporated herein by reference for all purposes.

### FIELD OF THE DISCLOSURE

The present disclosure is directed toward solid electrolyte materials and electrochemical cells containing the solid electrolyte materials, and methods of making the solid electrolyte materials. Therefore, the disclosure relates to the fields of batteries, including solid-state batteries, electronics, chemistry, and materials science.

### BACKGROUND

Li-ion batteries traditionally use liquid electrolytes, which, being made of flammable organic solvents, pose safety concerns. To address this, non-flammable solid-state electrolytes have been introduced, with sulfide solid electrolytes gaining attention for their high ionic conductivity. Notably, those with an argyrodite structure exhibit ionic conductivities comparable to standard liquid electrolytes. However, further progress in materials with argyrodite structures has been hindered by the inherent physical limits of this structure.

The performance of a sulfide-based solid-state battery heavily relies on the type of sulfide solid electrolyte used. Argyrodite-structured electrolytes, expressed by the formula Li⁺₍₁₂₋ₙ₋ₓ₎Bⁿ⁺X²⁻₆₋ₓY⁻ₓ (where Bⁿ⁺ is selected from the group consisting of P, As, Ge, Ga, Sb, Si, Sn, Al, In, Ti, V, Nb, and Ta; X²⁻ is selected from the group consisting of S, Se, and Te; Y⁻ is selected from the group consisting of Cl, Br, I, F, CN, OCN, SCN, and N₃; and 0≤x≤2) have garnered significant interest. While these materials exhibit ionic conductivities comparable to liquid electrolytes, the development has stalled due to the limitations of the argyrodite structure. Specifically, materials with the argyrodite crystal structure tend to have high material hardness. This material hardness hinders ideal contact between a fully argyrodite electrolyte and the electrode active materials used in the positive or negative electrode layers.

To overcome this material constraint, an electrolyte material with an argyrodite structure can be physically mixed with another electrolyte material having a more ideal material hardness—such as a Li₇P₃S₁₁ electrolyte material. To perform physical mixing, milling or grinding devices are used to ensure a homogeneous composite is formed. However, the milling or grinding causes a reduction in crystallinity of the electrolyte material with an argyrodite structure, causing its ionic conductivity to decrease. While the newly formed composite may be heated to reform the argyrodite crystal structure, the temperature needed to reform the argyrodite structure is higher than the decomposition temperature of the Li₇P₃S₁₁ material. Using this approach may reform the argyrodite structure but the resulting decomposition products of the Li₇P₃S₁₁ material result in the formation of a composite with even lower ionic conductivity.

Further, while other electrolyte materials with different chemical compositions or different crystal structures may be used in conjunction with, or in place of, argyrodite compounds, the ionic conductivities of these materials may be less ideal than those of argyrodite materials.

Therefore, there is a need for solid electrolyte compounds with new crystal structures—especially those which may maintain high ionic conductivities and advantageous electrical properties. Similarly, there is a need for improved methods for forming such compounds and solid electrolyte composites including the same.

### BRIEF SUMMARY

Aspects of the present disclosure provide a solid electrolyte compound comprising lithium, sulfur, and phosphorus and having a crystalline structure defined by an XRD pattern comprising peaks at 2θ=20.9°±0.5°, 31°±0.5°. and 33°±0.5°. The solid electrolyte compound may further include at least one halogen selected from Cl, Br, or I.

The XRD pattern of the disclosed solid electrolyte compound may further include peaks at 2θ=22.8°±0.5°, 26.2°±0.5°, and 32.1°±0.5°. In some embodiments, where the peak at 20.9°±0.5° has an intensity of I_{A}, and the peak at 33°±0.5° has an intensity of I_{C}, I_{A}>I_{C}. In some embodiments, where the peak at 31°±0.5° has an intensity of I_{B} and the peak at 33°±0.5° has an intensity of I_{C}, I_{B}>I_{C}.

Also disclosed is solid electrolyte composite including an argyrodite companion compound containing lithium, sulfur, and phosphorus and having a crystalline structure defined by an XRD pattern comprising peaks at 2θ=20.9±0.5°, 31°±0.5°. and 33°±0.5, and an argyrodite compound having a crystalline structure defined by an XRD pattern comprising peaks at 25.6±0.5°, 30.0±0.5°, 31.4°±0.5°.

In some embodiments, in the XRD pattern of the disclosed argyrodite companion compound, where the peak at 20.9°±0.5° has an intensity of I_{A}, and the peak at 30.0°±0.5° has an intensity of I_{Y}, 0<I_{A}:I_{Y}≤1. In some embodiments, where the peak at 20.9°±0.5° has an intensity of I_{A}, and the peak at 30.0°±0.5° has an intensity of I_{Y}, 0>I_{A}:I_{Y} is ≤1.

In some embodiments of the disclosed composite, the argyrodite companion compound is included in an amount of at least 20 wt % or at least 40 wt %. In some embodiments of the disclosed composite, the argyrodite companion compound is included in an amount of 90 wt % or less, or 70 wt % or less.

Also provided is a solid-state battery device included: an anode layer, a cathode layer, and a separator layer; where at least one of the anode layer, the cathode layer, and the separator layer includes a solid electrolyte compound comprising lithium, sulfur, and phosphorus and having a crystalline structure defined by an XRD pattern comprising peaks at 2θ=20.9°±0.5°, 31°±0.5°. and 33°±0.5°.

In some embodiments, the solid electrolyte compound of the solid-state battery device may additionally include at least one halogen selected from Cl, Br, or I. In some embodiments, the XRD pattern defining the crystalline structure of the solid electrolyte compound further includes peaks at 2θ=22.8°±0.5°, 26.2°±0.5°, and 32.1°±0.5°. In some embodiments, the solid electrolyte compound has an XRD peak at 20.9°±0.5° with a peak intensity of I_{A}, an XRD peak at 30.0°±0.5° with a peak intensity of I_{Y}, and where I_{A}:I_{Y} is >0.

### BRIEF DESCRIPTION OF THE FIGURES

The present disclosure may be understood by reference to the following detailed description taken in conjunction with the drawings briefly described below. It is noted that, for purposes of illustrative clarity, certain elements in the drawings may not be drawn to scale.

FIG. 1 shows an x-ray diffraction (XRD) plot of intensity (counts) versus diffraction angle (degrees 2-theta (2θ)), showing the results of XRD measurements using CuKα(1,2)=1.5418 Å radiation performed on the solid electrolyte prepared according to Example 1.

FIG. 2 shows an x-ray diffraction (XRD) plot of intensity (counts) versus diffraction angle (degrees 2-theta (2θ)), showing the results of XRD measurements using CuKα(1,2)=1.5418 Å radiation performed on the solid electrolyte prepared according to Example 2.

FIG. 3 shows an x-ray diffraction (XRD) plot of intensity (counts) versus diffraction angle (degrees 2-theta (2θ)), showing the results of XRD measurements using CuKα(1,2)=1.5418 Å radiation performed on the solid electrolyte prepared according to Example 3.

### DETAILED DESCRIPTION

Before various aspects of the present invention are disclosed and described, it is to be understood that this invention is not limited to the particular methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value.

Further, for the sake of convenience and brevity and in another example, a numerical range of “about 50 mg/mL to about 80 mg/mL” should also be understood to provide support for the range of “50 mg/mL to 80 mg/mL.”

In this disclosure, the terms “including,” “containing,” and/or “having” are understood to mean comprising, and are open ended terms.

The indefinite articles “a” and “an,” as used herein in the specification and in the claims, unless clearly indicated to the contrary, should be understood to mean “at least one.”

As used herein, the term “electrolyte” refers to a complete material suitable for use as the electrolyte in an electrochemical device. A “solid electrolyte” refers to an electrolyte in the solid state, which is suitable for use in the same state. The solid electrolyte or electrolyte may be a pure, i.e. single component material, with respect to both chemical and crystalline composition, or it may contain a mixture of components having different chemical compositions and/or crystalline structures.

As used herein, the term “composite” refers to a mixture of at least two components having distinct chemical compositions and/or crystalline structures.

As used herein, the term “compound” refers to a component defined by a single chemical composition and a single crystalline structure.

As used herein, the term “argyrodite companion compound” means a solid electrolyte compound containing at least lithium, sulfur, and phosphorus and having a crystalline structure defined by characteristic XRD peaks at 2θ=20.9±0.5°, 31°±0.5°. and 33°±0.5°. The term “argyrodite companion compound” is used herein, because the solid electrolyte compound containing at least lithium, sulfur, and phosphorus and having a crystalline structure defined by characteristic XRD peaks at 2θ=20.9±0.5°, 31°±0.5° may, in some cases, be formed and be utilized alongside and/or in a mixture with an argyrodite compound. However, the “argyrodite companion compound” disclosed and defined herein may also be formed and be used on its own, without the presence of an argyrodite compound. The disclosed “argyrodite companion compound” is not an argyrodite material and has a distinct crystalline structure from the argyrodite family.

As used herein, the term “characteristic peak” is used to refer to a peak which helps to identify and denote a crystalline structure defined by a complete XRD pattern. As such, as set of “characteristic peaks” is a selection of peaks present within a certain XRD pattern which may be used to define a certain crystalline structure and identify that complete XRD pattern.

However, the characteristic peaks may not be a complete listing of peaks present in the corresponding XRD pattern. That is, a crystalline structure or compound having a structure “defined by” certain characteristic peaks may have a complete XRD pattern which contains additional peaks beyond the disclosed or recited characteristic peaks.

This disclosure introduces a unique argyrodite companion compound having high ionic conductivity and low material hardness. This argyrodite companion compound is a sulfide solid electrolyte compound with a distinctive crystal structure defined by an XRD pattern featuring peaks at 2θ=20.9°±0.5°, 31°±0.5°, and 33°±0.5°. The argyrodite companion compound comprises at least lithium (Li), phosphorus (P), and sulfur (S). In some embodiments, the argyrodite companion compound consists of Li, P, and S, while in other aspects, the argyrodite companion compound may additionally include a halogen. The argyrodite companion compound of the present application, with its unique crystal structure, can be utilized in the positive electrode layer, negative electrode layer, and separator layer of a solid-state battery, either alone or in a composite.

In some aspects, the argyrodite companion compound can be formed in conjunction with and be present alongside an argyrodite material—while itself having a distinct crystalline structure from argyrodite materials. Thus, a solid electrolyte composite including the argyrodite companion compound is also disclosed. In addition to the argyrodite companion, the disclosed composite may additionally include an argyrodite-type structure component comprising lithium (Li), phosphorus (P), sulfur (S), and a halogen (X). The argyrodite-type structure component may be expressed by the formula Li⁺₍₁₂₋ₙ₋ₓ₎Bⁿ⁺X²⁻₆₋ₓY⁻x, where Bⁿ⁺ is selected from the group consisting of P, As, Ge, Ga, Sb, Si, Sn, Al, In, Ti, V, Nb, and Ta; X²⁻ is selected from the group consisting of S, Se, and Te; Y⁻ is selected from the group consisting of CI, Br, I, F, CN, OCN, SCN, and N₃; and 0≤x≤2. In some aspects, the argyrodite-type structure compound consists of Li, P, S, and at least one halogen selected from Cl, Br, or I. The disclosed composite including the argyrodite companion compound and another material, such as argyrodite, can be utilized in the positive electrode layer, negative electrode layer, and separator layer of a solid-state battery.

In some aspects, the argyrodite companion compound may be utilized on its own, without the presence of an argyrodite-type structure compound. That is, in some aspects, the argyrodite companion compound may be included in a composite that does not contain an argyrodite component (but may include other non-argyrodite materials). In other embodiments, the argyrodite companion compound may be present in a pure form.

The disclosed argyrodite companion compound may be prepared by mixing precursor materials comprising a lithium-containing precursor, a phosphorus-containing precursor, and a sulfur-containing precursor in appropriate amounts—for example, in stoichiometric amounts—to form a mixture, and performing a heat treatment on the mixture.

In some embodiments, the precursor materials additionally comprise a halogen-containing precursor. In a preferred embodiment, the precursor materials consist of a lithium-containing precursor, a phosphorus-containing precursor, and a sulfur-containing precursor.

To form the precursor mixture, processes such as milling, including ball milling, or pulverization may be used. Other processes such as dissolution of the precursors using polar or non-polar solvents may be employed. When dissolution methods are used, a drying process may be used to remove the solvent, after mixing, and prior to heat treatment. In a preferred embodiment, the precursor materials are mixed in stoichiometric amounts. However, in alternative embodiments, excess amounts of at least one precursor material may be used.

The mixture of precursors, may be heat-treated in an inert atmosphere to prepare a solid electrolyte including the disclosed argyrodite companion compound with the crystal structure defined by characteristic peaks at 2θ=20.9°±0.5°, 31°±0.5°, and 33°±0.5°. In some embodiments, the solid electrolyte may consist of the argyrodite companion compound having the crystal structure defined by the aforementioned XRD pattern and its characteristic peaks. However, in other embodiments, the produced solid electrolyte may comprise additional components, such as a compound having an argyrodite structure. In such embodiments, the additional components may be present only in trace amounts or may be present in more significant quantities, such that the solid electrolyte is a composite between at least two compounds.

The heat treatment may be performed at a temperature in a range of 200° C. to 700° C., preferably in a range of 300° C. to 600° C., more preferably in a range of 400° C. to 500° C., and most preferably in a range of 425° C. to 475° C. When the heat treatment is performed within an appropriate temperature within the disclosed ranges, the desired solid electrolyte compound with the crystal structure defined by characteristic peaks at 2θ=20.9°±0.5°, 310° 0.5°, and 33°±0.5° may be formed in adequate amounts. If the heat treatment is performed at excessively low temperatures, below the disclosed ranges, the material may not crystallize resulting in diminished material performance. Additionally, since adequate crystallization may not occur, the argyrodite companion compound may not be formed. This absence of the argyrodite companion compound may be demonstrated by the absence of characteristic peaks at 2θ=20.9°±0.5°, 31°±0.5°, and 33°±0.5°, and/or the absence of XRD peaks as a whole. Conversely, if the heat treatment is performed at high temperatures above the disclosed ranges the material may partially or fully decompose. Appropriate temperature ranges may further vary based on the type of precursor material and/or the time period over which the heat treatment is conducted.

The heat treatment may be conducted for a duration of 30 minutes to up to 36 hours, preferably for a duration of 30 minutes up to 12 hours, more preferably for a duration of 30 minutes to 6 hours, and most preferably for a duration of 30 minutes up to 2 hours. If the heat treatment is conducted for too short a time, e.g. below the disclosed ranges, sufficient crystallization may not occur, and the argyrodite companion compound may not be formed.

As disclosed above, the absence of the argyrodite companion compound may be demonstrated by the absence of characteristic peaks at 2θ=20.9°±0.5°, 31°±0.5°, and 33°±0.5°, and/or the absence of XRD peaks as a whole.

The heat treatment may be performed in an inert atmosphere, including a vacuum, or an area filled with an inert gas such as nitrogen and/or argon. If heat treatment is performed in a reactive atmosphere, the argyrodite companion compound may not be formed due to reaction of the gaseous atmosphere with the precursors.

When the aforementioned method is performed with appropriate relative amounts of precursors and with appropriate heat treatment conditions, the disclosed argyrodite companion compound may be produced. More specifically, the disclosed method may produce a solid electrolyte which includes the argyrodite companion compound in an amount ranging from greater than zero to 100 weight percent (wt %), based on a total amount of produced solid electrolyte. In some embodiments, the remainder of the solid electrolyte may be composed of an argyrodite compound. In some embodiments, the argyrodite companion compound is present in an amount of at least 4 wt %, preferably in an amount of at least 20 wt %, more preferably in an amount of at least 30 wt %, even more preferably in an amount of at least 40 wt %, and most preferably in an amount of at least 50 wt %, based on a total weight of solid electrolyte. In some embodiments, the argyrodite companion compound is present in amounts of 90 wt % or less, 70 wt % or less, or 60 w % or less.

The lithium-containing precursor may comprise at least one of Li₂S, Li₂SO₄, LiOH, or Li₂CO₃, but is not limited thereto. The phosphorus-containing precursor may comprise at least one of P₄S₁₀ (P₂S₅), P₄S₉, P₄S₇, P₄S₃, or P₄Sₓ where X is greater than 10, but is not limited thereto. The sulfur-containing precursor may comprise at least one of elemental sulfur, Na₂Sₓ, K₂Sₓ, Li₂Sₓ where X is greater than 1 but less than 8, NaSH, or LiSH, but is not limited thereto. The halogen-containing precursor may comprise at least one of LiF, LiCl. LiBr, LiI, or LiClₓBr_{y} where 0<x<1, 0<y<1, and where x+y=1, but is not limited thereto.

The disclosed argyrodite companion compound has a distinct crystalline structure defined by characteristic XRD peaks at 2θ=20.9°±0.5°, 310° 0.5°. and 33°±0.5°. The XRD peaks correspond to peak intensities which are expressed by the area under the curve for any given peak. For example, the XRD peak at 2θ=20.9°±0.5° exhibits a peak intensity of I_{A}, the XRD peak at 31°±0.5° has a peak intensity of I_{B}, and the XRD peak at 33°±0.5° has a peak intensity of I_{C}.

In the argyrodite companion compound the intensity of the peak at 20.9°±0.5° (I_{A}) is greater than the intensity of the peak at 33°±0.5° (I_{C}). This difference in peak intensities may be expressed by the formula: I_{A}>I_{C}. Additionally, in the argyrodite companion compound, the intensity of the peak at 31°±0.5° (I_{B}) is greater than the intensity of the peak at 33°±0.5° (I_{C}). The difference in peak intensities may be expressed by the formula: I_{B}>I_{C}. Additionally, the argyrodite companion material may have distinct XRD peaks located at 2θ=22.8°±0.5°, 26.2°±0.50, and 32.1°±0.5°.

In embodiments in which the argyrodite companion compound is present within a composite, the disclosed composite solid electrolyte material may further have distinct XRD peaks at a position of 25.6°±0.5°, 30.0° 0.5°, and 31.4°±0.5° which correspond to an argyrodite crystal structure. Electrolyte compounds with an argyrodite structure showcase an XRD peak at 25.6°±0.5° with a peak intensity referred to as Ix, an XRD peak at 30.0°±0.5° with a peak intensity referred to as I_{Y}, and an XRD peak at 31.4°±0.5° with a peak intensity referred to as I_{Z}.

In some implementations, the solid electrolyte composite has an XRD peak at 20.9°±0.5° with a peak intensity of I_{A}, and an XRD peak at 30.0°±0.5° with a peak intensity of I_{Y}. The ratio between the XRD peak intensity of the peak at 20.9°±0.5° (I_{A}) and the XRD peak intensity of the peak at 30.0°±0.5° (I_{Y}) follows the formula I_{A}:I_{Y}>0.

In embodiments where the argyrodite companion compound is present in a composite along with an argyrodite material, the composite may exhibit high ionic conductivities comparable to those exhibited by pure argyrodite electrolytes. For example, the composite may exhibit ionic conductivities of at least 70%, preferably at least 80%, more preferably at least 90%, and most preferably at least 95% of the ionic conductivity of a pure argyrodite type electrolyte material. Such high ionic conductivities may be present even when the argyrodite companion compound makes up at least 4 wt %, at least 20 wt %, at least 30 wt %, or at least 40 wt %, of the solid electrolyte, with the remainder being the argyrodite material.

Due to its favorable electrical properties, the disclosed argyrodite companion compound may be advantageously incorporated into a solid state battery device. The solid state battery device may include an anode layer, a cathode layer, and a separator layer, with the argyrodite compound being included in one or more of these layers. In some applications, the argyrodite companion compound may be incorporated into the solid state battery device in the form of one or more of the composites described herein.

### EXAMPLES

Examples have been set forth below for the purpose of illustration and to describe certain specific embodiments of the disclosure. However, the scope of the claims is not to be in any way limited by the examples set forth herein. Various changes and modifications to the disclosed embodiments will be apparent to those skilled in the art and such changes and modifications including, without limitation, those relating to the chemical structures, substituents, derivatives, formulations, or methods of the disclosure may be made without departing from the spirit of the disclosure and the scope of the appended claims. Definitions of the variables in the structures in the schemes herein are commensurate with those of corresponding positions in the formulae presented herein.

### Example 1

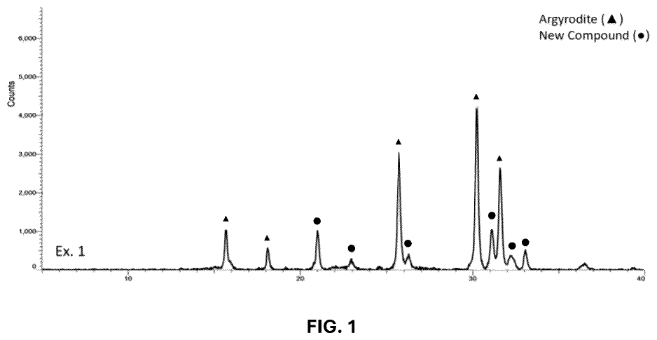

0.1905 g of LiCl, 0.5157 g of Li₂S, 0.3267 g of P₄S₃, and 0.6239 g of Elemental Sulfur were placed in a 50 ml vial together with 20 mls of anhydrous Ethanol. The contents of the vial were mixed for 30 minutes after which, the solvent was removed by placing the solution in vacuum environment and heating to 140° C. Any residual solvent was then removed from the mixture to form a dry powder. The dried powder was then heated to 450° C. for 1 hour. The resultant material was a crystalline solid state compound. An XRD plot was taken. A representation of that plot appears in FIG. 1.

### Example 2

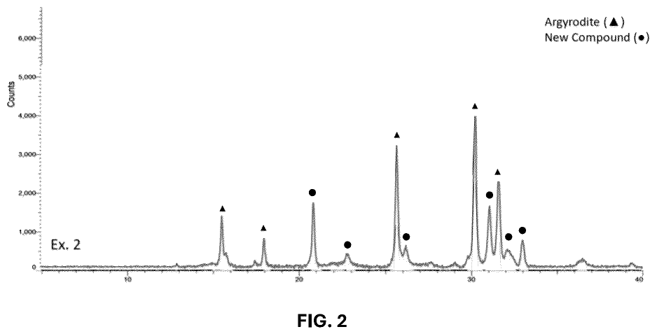

0.1905 g of LiCl, 0.5157 g of Li₂S, 0.3540 g of P₄S₃, and 0.6239 g Elemental Sulfur were placed in a 50 ml vial together with 20 mls of anhydrous Ethanol. The contents of the vial were mixed for 30 minutes after which, the solvent was removed by placing the solution in vacuum environment and heating to 140° C. Any residual solvent was then removed from the mixture to form a dry powder. The dried powder was then heated to 450° C. for 1 hour. The resultant material was a crystalline solid state compound. An XRD plot was taken. A representation of that plot appears in FIG. 2.

### Example 3

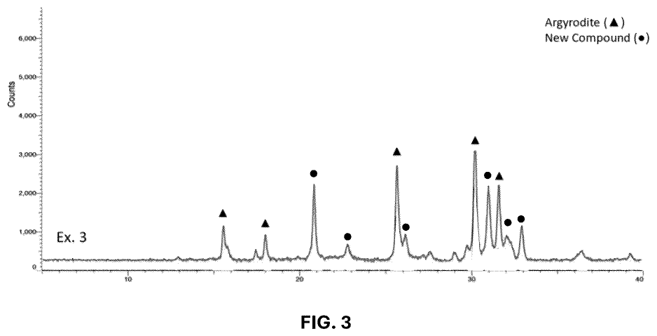

0.1905 g of LiCl, 0.5157 g of Li₂S, 0.3812 g of P₄S₃, and 0.6239 g of Elemental Sulfur were placed in a 50 ml vial together with 20 mls of anhydrous Ethanol. The contents of the vial were mixed for 30 minutes after which, the solvent was removed by placing the solution in vacuum environment and heating to 140° C. Any residual solvent was then removed from the solution to form a dry powder. The dried powder was then heated to 450° C. for 1 hour. The resultant material was a crystalline solid state compound. An XRD plot was taken. A representation of that plot appears in FIG. 3.

As shown in FIGS. 1-3, the Examples 1-3 produced a set of electrolyte composites which each contain the unique argyrodite companion compound.

FIGS. 1-3 show the argyrodite companion material having XRD peaks at 2θ=20.9°±0.5°, 31°±0.5°. and 33°±0.5° which are marked by the (●) symbol. FIG. 1 also shows XRD peaks at 25.6°±0.5°, 30.0°±0.5°, 31.4°±0.5°, which are marked by the (▴) symbol and belong to the Argyrodite structure.

FIGS. 1-3 also show a solid-state electrolyte composite having an XRD peak at 20.9°±0.5° belonging to the argyrodite companion compound having a specific peak (I_{A}) and the XRD peak at 30.0°±0.5° belonging to the electrolyte material from the argyrodite family having a specific peak intensity (I_{Y}). Comparing the two peak intensities, FIG. 1 demonstrates that 0<I_{A}:I_{Y}≤1.

What is claimed is:

1. A solid electrolyte compound comprising lithium, sulfur, and phosphorus and having a crystalline structure defined by an XRD pattern comprising peaks at 2θ=20.9°±0.5°, 31°±0.5°. and 330±0.5°.

2. The compound of claim 1, further comprising at least one halogen selected from Cl, Br, or I.

3. The compound of claim 1, wherein the XRD pattern further comprises peaks at 2θ=22.8°±0.5°, 26.2°±0.5°, and 32.1°±0.5°.

4. The electrolyte compound of claim 1, wherein the peak at 20.9°±0.5° has an intensity of I_{A}, the peak at 33°±0.5° has an intensity of I_{C}, and I_{A}>I_{C}.

5. The electrolyte compound of claim 1, wherein the peak at 31°±0.5° has an intensity of I_{B} and the peak at 33°±0.5° has an intensity of I_{C}, and I_{B}>I_{C}.

6. A solid electrolyte composite comprising:
an argyrodite companion compound comprising lithium, sulfur, and phosphorus and having a crystalline structure defined by an XRD pattern comprising peaks at 2θ=20.9°±0.5°, 31°±0.5°. and 33°±0.5, and
an argyrodite compound having a crystalline structure defined by an XRD pattern comprising peaks at 25.6±0.5°, 30.0°±0.5°, 31.4°±0.5°.

7. The solid electrolyte composite of claim 6, wherein the peak at 20.9°±0.5° has an intensity of I_{A}, the peak at 30.0°±0.5° has an intensity of I_{Y}, and 0<I_{A}:I_{Y}≤1.

8. The solid electrolyte composite of claim 6, wherein the peak at 20.9°±0.5° has an intensity of I_{A}, the peak at 30.0°±0.5° has an intensity of I_{Y}, and 0>I_{A}:I_{Y} is ≤1.

9. The solid electrolyte composite of claim 6, wherein the argyrodite companion compound is included in an amount of at least 20 wt %.

10. The solid electrolyte composite of claim 6, wherein the argyrodite companion compound is included in an amount of at least 40 wt %.

11. The solid electrolyte composite of claim 6, wherein the argyrodite companion compound is included in an amount of 90 wt % or less.

12. The solid electrolyte composite of claim 6, wherein the argyrodite companion compound is included in an amount of 70 wt % or less.

13. The solid electrolyte composite of claim 6, having a crystalline structure defined by the XRD pattern of at least one of FIG. 1, FIG. 2, or FIG. 3.

14. A solid-state battery device comprising:
an anode layer, a cathode layer, and a separator layer;
wherein at least one of the anode layer, the cathode layer, and the separator layer comprises the solid electrolyte composite of claim 6.

15. A solid-state battery device comprising:
an anode layer, a cathode layer, and a separator layer;
wherein at least one of the anode layer, the cathode layer, and the separator layer comprises a solid electrolyte compound comprising lithium, sulfur, and phosphorus and having a crystalline structure defined by an XRD pattern comprising peaks at 2θ=20.9°±0.5°, 310° 0.5°. and 330±0.5°.

16. The solid-state battery device of claim 15, wherein the solid electrolyte compound further comprises at least one halogen selected from Cl, Br, or I.

17. The solid-state battery device of claim 15, wherein the XRD pattern defining the crystalline structure of the solid electrolyte compound further comprises peaks at 2θ=22.8°±0.5°, 26.2°±0.5°, and 32.1°±0.5°.

18. The solid-state battery device of claim 15, wherein the solid electrolyte compound has XRD peak at 20.9°±0.5° with a peak intensity of I_{A}, an XRD peak at 30.0°±0.5° with a peak intensity of I_{Y}, and where I_{A}:I_{Y} is >0.
